(19) United States
(12) Patent Application Publication
(10) Pub. No.: US 2016/0305229 A1
(43) Pub. Date: Oct. 20, 2016

(54) HYDRAULIC FRACTURING METHOD

(71) Applicant: HALLIBURTON ENERGY SERVICES, INC., Houston, TX (US)

(72) Inventors: Jesse Clay Hampton, Conroe, TX (US); Aaron Gene Russell, Humble, TX (US)

(21) Appl. No.: 15/103,788

(22) PCT Filed: Feb. 27, 2014
(86) PCT No.: PCT/US2014/019104

§ 371 Date: Jun. 10, 2016

(51) Int. Cl. E21B 43/26; C09K 8/68; C09K 8/90; E21B 43/267

(52) U.S. Cl. CPC E21B 43/26; E21B 43/267; C09K 8/685; C09K 8/68; C09K 8/90

(57) ABSTRACT

Methods relating to using fracturing fluids in fracturing process for fracturing of subterranean formations are provided. The methods comprise sequentially injecting into a wellbore, alternating stages of a low-viscosity fracturing fluid having a first viscosity and a high-viscosity fracturing fluid having a second viscosity, wherein there is a viscosity difference such that the first viscosity is lower than the second viscosity.

### FIELD OF THE INVENTION

The present invention relates to fracturing fluids for fracturing of subterranean formations.

### BACKGROUND

In the drilling, completion and treatment of subterranean formations penetrated by wellbores, viscous treating fluids are commonly utilized in hydraulic fracturing operations. Hydraulic fracturing operations generally involve pumping a fracturing fluid into a wellbore that penetrates a subterranean formation at a sufficient hydraulic pressure to create or enhance one or more cracks, or “fractures,” in the subterranean formation. “Enhancing” one or more fractures in a subterranean formation, as that term is used herein, is defined to include the extension or enlargement of one or more natural or previously created fractures in the subterranean formation. The treatment fluid may comprise particulates, often referred to as “proppant particulates,” that are deposited in the fractures. The proppant particulates, inter alia, may prevent the fractures from fully closing upon the release of hydraulic pressure, forming conductive channels through which fluids may flow. When at least one fracture is created and/or enhanced, and the proppant particulates are substantially in place, the fracturing fluid may be may be recovered from the formation.

To provide the desired viscosity, polymeric gelling agents commonly are added to the treatment fluids. These gelling agents, when hydrated and at a sufficient concentration, are capable of forming a viscous solution. When used to make an aqueous-based viscosified treatment fluid, a gelling agent is combined with an aqueous fluid and the soluble portions of the gelling agent are dissolved in the aqueous fluid, thereby increasing the viscosity of the fluid.

### BRIEF DESCRIPTION OF THE DRAWINGS

The drawing is provided to illustrate certain aspects of the invention and should not be used to limit or define the invention.

FIG. 1 is a schematic illustration generally depicting a rig assembly and borehole during a fracturing process.

### DESCRIPTION OF SPECIFIC EMBODIMENTS

A hydraulic fracturing treatment in accordance with an embodiment comprises a first stage in which a first viscosified treatment fluid is pumped into a well faster than the fluid can escape into the formation so that the pressure rises and the rock breaks, creating artificial fracturing and/or enlarging existing fractures. A second viscosified treatment fluid having a higher viscosity than the first fluid is then pumped into the well in a second stage treatment. The second stage treatment with higher viscosity fluid than the first stage creates additional fracturing and further enlarges existing fractures (both existing prior to the first stage and those introduced during the first stage) beyond the enlargement caused by the first fluid. Additional stages of sequentially injecting fluids into the wellbore, alternating stages of lower viscosity fracturing fluid (“low-viscosity fluid”) and higher viscosity fracturing fluid (“high-viscosity fluid”), can be carried out such that the stages complement each other in creating fractures and enlarging fractures. Generally, a propping agent such as sand can be added to the fluids in one or more of the stages to form a slurry that is pumped into the fractures to prevent them from closing when pumping pressure is released. Additionally, in some embodiments the first stage will utilize the second more viscosified treatment fluid and the second stage will use the first less viscosified treatment fluid, which can be followed by additional sequentially alternating stages. Also, it will be appreciated that where there are several such sequentially alternating stages, the low-viscosity fluids used in the lower viscosity stages can be of differing viscosity as long as they have a lower viscosity than the high-viscosity fluids used in the higher viscosity stages. Similarly, the high-viscosity fluid used in the higher viscosity stages can have differing viscosities as long as they have a higher viscosity than the low-viscosity fluids used in the lower viscosity stages.

The viscosified treatment fluids utilized generally comprise a base fluid and an additive that increases the viscosity of the viscosified treatment fluid over the base fluid alone (“viscosifier”). Suitable base fluids include aqueous base fluids and nonaqueous base fluids. Suitable aqueous base fluids that may be used in the viscosified treatment fluids of the present invention may include fresh water, salt water, brine, formation brine, seawater, or any other aqueous fluid that, preferably, does not adversely interact with the other components used in accordance with this invention or with the subterranean formation. Suitable nonaqueous base fluids that may be used in the viscosified treatment fluids may include glycerol, glycol, polyglycols, ethylene glycol, propylene glycol, and dipropylene glycol methyl ether. In some embodiments, the base fluid may be present in the viscosified treatment fluids of the present invention in an amount in the range from about 5% to 99.99% by volume of the viscosified treatment fluid.

In some embodiments, the base fluids suitable for use in the viscosified treatment fluids of the present invention may be a foamed fluid (e.g., a liquid that comprises a gas such as nitrogen, carbon dioxide, air or methane). As used herein, the term “foamed” also refers to co-mingled fluids. In certain embodiments, it may desirable that the base fluid is foamed to, inter alia, reduce the amount of base fluid that is required, e.g. in water-sensitive subterranean formations, to reduce fluid loss to the subterranean formation, and/or to provide enhanced proppant suspension. While various gases can be utilized for foaming the treatment fluids of this invention, nitrogen, carbon dioxide, and mixtures thereof are preferred. In examples of such embodiments, the gas may be present in a viscosified treatment fluid of the present invention in an amount in the range of from about 5% to about 98% by volume of the treatment fluid, and more preferably in the range of from about 20% to about 80%. The amount of gas to incorporate into the fluid may be affected by factors including the viscosity of the fluid and wellhead pressures involved in a particular application.

Suitable viscosifiers for aqueous based fluids include water-soluble polymers. Such water-soluble polymer include guar gums, guar derivatives, cellulose-based derivatives, high-molecular weight polysaccharides composed of mannose and galactose sugars, xanthan and other natural polymers and their derivatives. Additionally, synthetic polymers, such as polyacrylamides and polyacrylates, can be used as the viscosifier. Guar derivatives, for example, include hydropropyl guar (HPG), carboxymethyl guar (CMG), carboxymethylhydropropyl guar (CMHPG) and hydroxyethylated guar (HEG). Cellulose derivatives, for example, include hydroxyethylcellulose (HEC), hydroxypropylcellulose (HPC), carboxymethyl cellulose (CMC) and carboxymethylhydroxyethylcellulose (CMHEC).

The polymers used as viscosifiers can be linear polymer but, where higher viscosities are desired, the linear polymers can be crosslinked. Various crosslinking agents can be used in association with the above viscosifiers to achieve such higher viscosities, typically where reservoir conditions indicate that greater viscosities differences between the low-viscosity fluid and the high-viscosity fluid would be useful, as further described below. Crosslinking agents are known in the art and may, for example, be based on boron, titanium, zirconium or aluminum complexes and can be used to increase the effective molecular weight of the polymer to achieve such higher viscosities in the viscosified treatment fluid.

Typically, the concentration of viscosifier in the base fluid will depend on the desired viscosity. Often such concentrations are from about 5 lb per 1000 gallon of base fluid to about 100 lb per 1000 gallons of base fluid.

In certain embodiments, the viscosified treatment fluids of the present invention also may optionally comprise salts, pH control additives, surfactants, breakers, bactericides, crosslinkers, fluid loss control additives, stabilizers, chelants, scale inhibitors, paraffin inhibitors, asphaltene inhibitors, mutual solvents, solvents, corrosion inhibitors, hydrate inhibitors, clay stabilizers, salt substitutes (such as tetramethyl ammonium chloride), relative permeability modifiers (such as HPT-1™ chemical additive available from Halliburton Energy Services, Duncan, Okla.), sulfide scavengers, fibers, nanoparticles, consolidating agents (such as resins and/or tackifiers), combinations thereof, or the like.

Also, during some or all stages of the process, the viscosified treatment fluids can contain proppants as are known in the art. The proppant type can be sand, intermediate strength ceramic proppants (available from Carbo Ceramics, Norton Proppants, etc.), sintered bauxites and other materials known to the industry. Any of these base propping agents can further be coated with a resin (available from Santrol, a Division of Fairmount Industries, Borden Chemical, etc.) to potentially improve the clustering ability of the proppant. In addition, the proppant can be coated with resin or a proppant flowback control agent such as fibers, for instance, can be simultaneously pumped. By selecting proppants having a contrast in one of such properties such as density, size and concentrations, different settling rates will be achieved.

The current process utilizes one or more low-viscosity fluids and one or more high-viscosity fluids. The low-viscosity fluids and high-viscosity fluids each are in accordance with the above-described viscosified treatment fluids; however, the high-viscosity fluids will have typically have a greater concentration of viscosifiers so as to have a substantially greater viscosity than the low-viscosity fluids. While the low-viscosity treatment fluids and high-viscosity treatment fluids can utilize different viscosifiers, in one embodiment the low-viscosity treatment fluids and high-viscosity treatment fluids utilize the same viscosifier (or combination of viscosifiers) with only the concentration of the viscosifier being different.

The viscosity difference between the low-viscosity fluid and high-viscosity fluid should be sufficient so that the high-viscosity fluid will enhance the fractures created by the low-viscosity fluid or, in other words, will widen and lengthen the fractures. Generally, the viscosities of the viscosified treatment fluids used in the current process will be in the range 1 to 10,000 cP, or higher. Also, typically the high-viscosity fluid having a viscosity of at least 10 times that of the low viscosity fluid. While it is possible to achieve some of the benefits of the current process with lower viscosity differences and while the exact viscosity differential utilized will depend on the reservoir conditions, often the high-viscosity fluid can have a viscosity of at least 10 times that of the low-viscosity fluid and, in some circumstances at least 100 times the viscosity of the low-viscosity fluid. In other circumstances the high-viscosity fluid can have a viscosity of at least 1000 times that of the low-viscosity fluid. Useful viscosity differentials can be determined by one skilled in the art, based on the reservoir conditions and this disclosure.

The viscosity of the low-viscosity and high-viscosity fluids will depend on reservoir conditions; however, often the low-viscosity fluid can have a viscosity of no more than 50 cP and the high-viscosity fluid can have a viscosity of greater than 50 cP. Typically, the low-viscosity fluid can have viscosity in the range of 1 to 50 cP and the high viscosity fracturing fluid can have a viscosity in the range of from 75 to 10,000 cP and, alternatively, the low-viscosity fluid can have viscosity in the range of 5 to 40 cP and the high-viscosity fluid can have a viscosity in the range of from 100 to 5000 cP or can be 400 to 1000 cP.

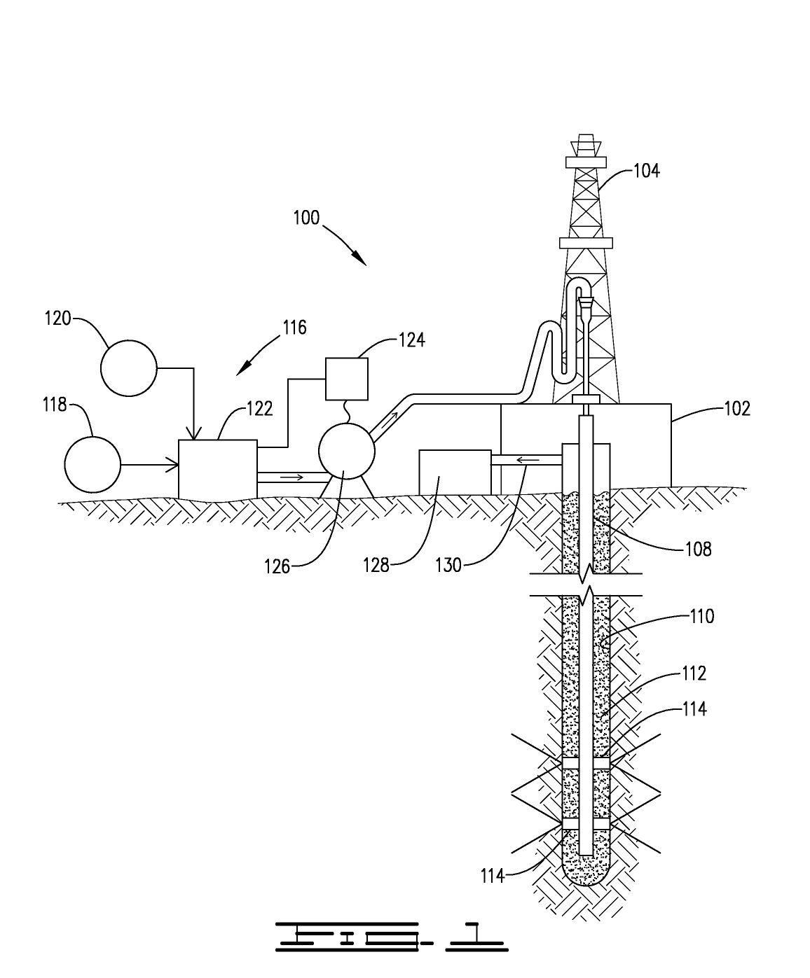

The fracturing fluid compositions disclosed herein may directly or indirectly affect one or more components or pieces of equipment associated with the preparation, delivery, recapture, recycling, reuse, and/or disposal of the disclosed fracturing fluid compositions. For example, and with reference to FIG. 1, the disclosed fracturing fluid compositions may directly or indirectly affect one or more components or pieces of equipment associated with an exemplary wellbore rig assembly 100, according to one or more embodiments. It should be noted that while FIG. 1 generally depicts a land-based rig assembly, those skilled in the art will readily recognize that the principles described herein are equally applicable to subsea drilling operations that employ floating or sea-based platforms and rigs, without departing from the scope of the disclosure. Additionally, it should be noted that FIG. 1 illustrates only one of several rig types useable with the principles described herein.

As illustrated, the drilling assembly 100, which may be used in an embodiment, may include a platform 102 that supports a derrick 104. The casing or tubing 108 extends into a wellbore 110. Cement 112 surrounds the casing 108 within the annulus between the wellbore 110 and casing 108. The casing and cement have been perforated at 114.

A mixing unit 116 includes a source of fracturing fluid 118, which is generally the base fluid. Also, mixing unit 116 includes a source of viscosifier 120 and a mixing apparatus 122. A control unit 124 is operationally connected to mixing unit 116 so as to control the concentration of viscosifier introduced into the fracturing fluid, and thus, controlling the viscosity of the resulting fracturing fluid slurry. Accordingly, mixing unit 116 can be configured to produce fluids having different viscosities.

A pump 126 introduces fluid from the mixing unit to the wellbore at a rate sufficient to increase downhole pressure at a portion of the reservoir to exceed the fracture gradient of rock forming said subterranean formation. As illustrated, this occurs at perforations 114. Control unit 124 is configured to sequentially introduce alternating stages of a first fracturing fluid slurry at a first viscosity and a second fracturing fluid slurry at a second viscosity. The second viscosity being greater than the first viscosity.

Fracturing fluid returning from downhole can be conveyed to one or more fluid processing unit(s) 128 via an interconnecting flow line 130. After passing through the fluid processing unit(s) 128, a “cleaned” fracturing fluid can be used as a source for mixing unit 116.

### Prophetic Examples

The following prophetic examples are provided to illustrate the inventive process. The examples were not actually carried out. The examples are not intended and should not be taken to limit, modify or define the scope of the present invention in any manner.

In a conventional pumping schedule, a viscous treatment fluid is pumped at a constant rate of 35 bbl/min. Table 1 shows the viscosity of the fracturing fluid, volume pumped per stage, the proppant concentration and the pumping time. The viscous treatment fluid is an uncrosslinked guar in water at a concentration sufficient to result in a viscosity of 30 cP.

TABLE 1

| | | | | Slurry | Pumping |
|---|---|---|---|---|---|
| | | | Proppant | Volume | Time |
| Stages | Fluid | Viscosity | Concentration | (bbl) | (minutes) |
| 1 | Water/Guar | 30 cP | 0.0 | 2400 | 70 |
| 2 | Water/Guar | 30 cP | 1.0 | 500 | 15 |
| 3 | Water/Guar | 30 cP | 2.0 | 500 | 15 |
| 4 | Water/Guar | 30 cP | 3.0 | 300 | 25 |
| 5 | Water/Guar | 30 cP | 4.0 | 800 | 25 |
| 6 | Water/Guar | 30 cP | 5.0 | 600 | 20 |
| 7 | Water/Guar | 30 cP | 6.0 | 500 | 15 |
| 8 | Water/Guar | 30 cP | 7.0 | 300 | 10 |
| Flush | Water/Guar | 30 cP | 0.0 | 60 | 2 |

As shown in Table 2, an example of a fracturing process in accordance with an embodiment is illustrated. The fracturing process utilizes sequentially alternating stages of a low-viscosity fluid and a high-viscosity fluid. Both fluids are uncrosslinked guar in water. The low-viscosity fluid contains guar in a concentration sufficient to result in a viscosity of 20 cP. The high-viscosity fluid contains guar in a concentration sufficient to result in a viscosity of 2000 cP.

TABLE 2

| | | | | | Slurry | Pumping |
|---|---|---|---|---|---|---|
| | | | | Proppant | Volume | Time |
| Stages | Fluid | Viscosity | | Concentration | (bbl) | (minutes) |
| 1 | Water/Guar | 20 | cP | 0.0 | 2400 | 70 |
| 2 | Water/Guar | 2000 | cP | 1.0 | 500 | 15 |
| 3 | Water/Guar | 20 | cP | 2.0 | 500 | 15 |
| 4 | Water/Guar | 2000 | cP | 3.0 | 300 | 25 |
| 5 | Water/Guar | 20 | cP | 4.0 | 800 | 25 |
| 6 | Water/Guar | 2000 | cP | 5.0 | 600 | 20 |
| 7 | Water/Guar | 20 | cP | 6.0 | 500 | 15 |
| 8 | Water/Guar | 2000 | cP | 7.0 | 300 | 10 |
| Flush | Water/Guar | 20 | cP | 0.0 | 60 | 2 |

As shown in Table 3, an example of a fracturing process, in accordance with an alternative embodiment of the invention, is illustrated. The fracturing process utilizes sequentially alternating stages of low-viscosity fluids and high-viscosity fluids. The fluids are uncrosslinked guar in water. The low-viscosity fluids contain guar in concentrations sufficient to result in a viscosity of less than 50 cP. The high-viscosity fluids contain guar in concentrations sufficient to result in a viscosity of 100 cP or greater.

TABLE 1

| | | | | | Slurry | Pumping |
|---|---|---|---|---|---|---|
| | | | | Proppant | Volume | Time |
| Stages | Fluid | Viscosity | | Concentration | (bbl) | (minutes) |
| 1 | Water/Guar | 10 | cP | 0.0 | 2400 | 70 |
| 2 | Water/Guar | 1000 | cP | 1.0 | 500 | 15 |
| 3 | Water/Guar | 20 | cP | 2.0 | 500 | 15 |
| 4 | Water/Guar | 2000 | cP | 3.0 | 300 | 25 |
| 5 | Water/Guar | 30 | cP | 4.0 | 800 | 25 |
| 6 | Water/Guar | 2500 | cP | 5.0 | 600 | 20 |
| 7 | Water/Guar | 20 | cP | 6.0 | 500 | 15 |
| 8 | Water/Guar | 1000 | cP | 7.0 | 300 | 10 |
| Flush | Water/Guar | 10 | cP | 0.0 | 60 | 2 |

In furtherance of the above description, several embodiments will now be described. In one embodiment there is provided a method of fracturing a subterranean formation comprising sequentially injecting into a wellbore, alternate stages of a low-viscosity fracturing fluid having a first viscosity and a high-viscosity fracturing fluid having a second viscosity, wherein there is a viscosity difference such that the first viscosity is lower than the second viscosity. Typically the viscosity difference is sufficient so that the high-viscosity fracturing fluid will widen fractures in the subterranean formation generated by the low-viscosity fracturing fluid. For example, the second viscosity can be at least 10 times the first viscosity. Alternatively, the second viscosity can be at least 100 times the first viscosity or the second viscosity can be at least 1000 times the first viscosity. Also, at least a portion of the stages can include a proppant.

In one aspect of this embodiment, the low-viscosity fracturing fluid can comprise a base fluid and a viscosifier and the high-viscosity fracturing fluid can comprise the same base fluid and the same viscosifier. The concentration of the viscosifier is higher in the high-viscosity fracturing fluid than it is in the low-viscosity fracturing fluid thus resulting in the second viscosity being higher than the first viscosity. In a further aspect, the base fluid can be an aqueous fluid and the viscosifier can be a linear polymer. In yet a further aspect, the high-viscosity fracturing fluid can further comprise a crosslinker to thereby generate a crosslinked polymer from the linear polymer.

In another embodiment, the first viscosity can be no greater than 50 cP and the second viscosity can be greater than 50 cP. Alternatively, the first viscosity can be in the range of from 1 cP to 50 cP and the second viscosity can be in the range of from 75 cP to 5000 cP. Still further, the first viscosity can be in the range of from 5 cP to 50 cP and the second viscosity can be in the range of from 100 cP to 1000 cP.

In still another embodiment, a system for fracturing a subterranean formation comprises a mixing unit, a control unit, a wellbore and a pump. The mixing unit has a source of fracturing fluid; a source of viscosifier; and a mixing apparatus for admixing fracturing fluid and viscosifier. The control unit is operationally connected to the mixing unit such that the mixing unit can be configured to produce a first fluid having a first viscosity or a second fluid having a second viscosity, wherein the first viscosity is lower than the second viscosity. The wellbore penetrates the subterranean formation. The pump introduces fluid from the mixing unit to the wellbore at a rate sufficient to increase downhole pressure at a portion of the reservoir to exceed the fracture gradient of rock forming the subterranean formation, wherein the control unit is configured to sequentially introduce alternating stages of the first fluid and the second fluid.

Further, the first fluid can comprise a base fluid and a viscosifier; the second fluid can comprise the same base fluid and the same viscosifier. The concentration of the viscosifier is higher in the second fluid than it is in the first fluid. In some aspects of this embodiment, the base fluid is aqueous fluid and the viscosifier is a linear polymer. In a further aspect, the high-viscosity fracturing fluid further comprises a crosslinker to thereby generate a crosslinked polymer from the linear polymer.

Also, at least a portion of the stages can include a proppant introduced with the first fluid or the second fluid. Further, the difference between the first viscosity and the second viscosity can be sufficient so that the second fluid will widen fractures in the subterranean formation generated by the low-viscosity fracturing fluid. Accordingly, the second viscosity can be at least 10 times the first viscosity. Alternatively, the second viscosity can be at least 100 times or at least 1000 times the first viscosity.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present invention. While compositions and methods are described in terms of “comprising,” “containing,” “having,” or “including” various components or steps, the compositions and methods can also “consist essentially of” or “consist of” the various components and steps. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee.

1. A method of fracturing a subterranean formation comprising sequentially injecting into a wellbore, alternating stages of a low-viscosity fracturing fluid having a first viscosity and a high-viscosity fracturing fluid having a second viscosity, wherein there is a viscosity difference such that said first viscosity is lower than said second viscosity.

2. The method of claim 1 wherein said viscosity difference is sufficient so that said high-viscosity fracturing fluid will widen fractures in said subterranean formation generated by said low-viscosity fracturing fluid.

3. The method of claim 1 wherein said second viscosity is at least 10 times said first viscosity.

4. The method of claim 3 wherein said second viscosity is at least 100 times said first viscosity.

5. The method of claim 4 wherein said second viscosity is at least 1000 times said first viscosity.

6. The method of claim 1 wherein said low-viscosity fracturing fluid comprises a base fluid and a viscosifier, said high-viscosity fracturing fluid comprises said base fluid and said viscosifier, and wherein said concentration of said viscosifier is higher in said high-viscosity fracturing fluid than it is in said low-viscosity fracturing fluid.

7. The method of claim 6 wherein said base fluid is aqueous fluid and said viscosifier is a linear polymer.

8. The method of claim 7 wherein said high-viscosity fracturing fluid further comprises a crosslinker to thereby generate a crosslinked polymer from said linear polymer.

9. The method of claim 1 wherein at least a portion of said stages include a proppant.

10. A method for fracturing a subterranean formation comprising sequentially injecting into a wellbore, alternate stages of a low-viscosity fracturing fluid having a first viscosity and a high-viscosity fracturing fluid having a second viscosity, wherein said first viscosity is no greater than 50 cP and said second viscosity is greater than 50 cP.

11. The method of claim 10 wherein said first viscosity is in the range of from 1 cP to 50 cP and said second viscosity in the range of from 75 cP to 10,000 cP.

12. The method of claim 10 wherein said first viscosity is in the range of from 5 cP to 50 cP and said second viscosity is in the range of from 100 cP to 5000 cP.

13. A system for fracturing a subterranean formation comprising:
a mixing unit having:
a source of fracturing fluid;
a source of viscosifier; and
a mixing apparatus for admixing fracturing fluid and viscosifier;
a control unit operationally connected to said mixing unit such that said mixing unit can be configured to produce a first fluid having a first viscosity or a second fluid having a second viscosity, wherein said first viscosity is lower than said second viscosity;
a wellbore penetrating said subterranean formation;
a pump for introducing fluid from said mixing unit to said wellbore at a rate sufficient to increase downhole pressure, at a portion of said reservoir to exceed the fracture gradient of rock forming said subterranean formation, wherein said control unit is configured to sequentially introduce alternating stages of said first fluid and said second fluid.

14. The system of claim 13 wherein said first fluid comprises a base fluid and a viscosifier, said second fluid comprises said base fluid and said viscosifier, and wherein said concentration of said viscosifier is higher in said second fluid than it is in said first fluid.

15. The system of claim 14 wherein said base fluid is aqueous fluid and said viscosifier is a linear polymer.

16. The system of claim 15 wherein said high-viscosity fracturing fluid further comprises a crosslinker to thereby generate a crosslinked polymer from said linear polymer.

17. The system of claim 13 wherein at least a portion of said stages include a proppant introduced with said first fluid or said second fluid.

18. The system of claim 13 wherein the difference between said first viscosity and said second viscosity is sufficient so that said second fluid will widen fractures in said subterranean formation generated by said low-viscosity fracturing fluid.

19. The system of claim 18 wherein said second viscosity is at least 10 times said first viscosity.

20. The system of claim 19 wherein said second viscosity is at least 100 times said first viscosity.
